(19) United States
(12) Patent Application Publication
(10) Pub. No.: US 2008/0047656 A1
(43) Pub. Date: Feb. 28, 2008

(54) Method of manufacturing a belt

(76) Inventors: Gerhard Hans Fickenwirth, Beverly, MA (US); Bret Morrison, Windham, NH (US)

Correspondence Address: THE GATES CORPORATION, IP LAW DEPT. 10-A3, 1551 WEWATTA STREET, DENVER, CO, 80202, US

(21) Appl. No.: 11/510,882

(22) Filed: Aug. 28, 2006

(51) Int. Cl. F16G 5/00

(52) U.S. Cl. 156/140

(57) ABSTRACT

A method of producing a toothed belt having teeth and grooves and a polymeric film cover thereon comprising the steps of rotating a forming wheel comprising alternating cavities and protrusions which correspond in cross section to a cross section of said toothed belt, extruding heated extrudable material onto the forming wheel, feeding a reinforcing member onto said forming wheel, feeding a polymeric film onto said forming wheel between the reinforcing member and the forming wheel, pressing said polymeric film into said cavities and upon said protrusions with said heated extrudable material thereby forming a polymeric film cover on the teeth and grooves, and cooling the toothed belt.

### FIELD OF THE INVENTION

The invention relates to a method of manufacturing a toothed belt having a polymeric film cover by using heated extrudable material pressing said film into said teeth to form a film cover on the teeth and grooves on the toothed side of said belt.

### BACKGROUND OF THE INVENTION

Traditional toothed timing belts have been produced with a neoprene rubber body, reinforcing cords of fiberglass, steel, polyester or Kevlar, and a nylon fabric which is used to reinforce the surface of the timing belt teeth. In the case of neoprene, it is a low cost body material. Neoprene has good chemical and oil resistance and is resistant to reasonably high temperatures. The weakness of neoprene for timing belt usage is that it has poor abrasion resistance, tear strength, tensile, compression set and deflection characteristics. The teeth of a timing belt must be tough and durable. Neoprene alone is not adequate and requires the additional strength and abrasion resistance that the nylon fabric can add. As a result many neoprene belts utilize this fabric and the composite belt is quite acceptable for use in power transmission applications.

Other toothed belts are produced with a polyurethane (PU) body instead of neoprene. Polyurethane offers several advantages. Polyurethane has very good abrasion resistance, tensile strength, tear and shear strength, chemical resistance etc. as compared to neoprene. Its primary drawback by comparison is its temperature resistance.

The characteristics of polyurethane make it ideal for conveying and positioning applications. Neoprene on the other hand is used more for power transmission applications where temperature and cost are more important. When PU belts are used for power transmission (PT) a major weakness is the friction between the bare polyurethane tooth and the pulley surface. The high friction generates additional heat which in turn further contributes to the heat problem with PU belts. As a result, in some applications for PU belts, it is also necessary to add nylon fabric to the face of the teeth. The nylon fabric is expensive to add to the belt and also tends to wear quickly and frays and unravels as it wears.

For some types of PU belts such as cast endless belts, the process does not allow for the addition of nylon.

Representative of the art is U.S. Pat. No. 4,515,743 which discloses a method of producing a reinforced plastics toothed belt having a fabric cover on the toothed side of the belt. Formed between a forming wheel and a forming wheel cover is a mold cavity into which the liquid plastics material, the reinforcing wires, and the strip of fabric are introduced. The strip of fabric, which is resiliently extensible in its longitudinal direction, is wetted, in the unextended state, before being introduced into the mold cavity, with an adhesive agent which hardens by drying and softens again under the temperature of the liquid plastics material. After the drying of the adhesive agent, the strip of fabric is introduced into the mold cavity and is placed on the teeth of the forming wheel. In the mold cavity, the strip of fabric is heated on meeting the liquid plastics material, is made resiliently extensible again as the adhesive agent softens, and is pressed into the grooves between the teeth of the forming wheel by the plastics material.

What is needed is a method of producing a toothed belt having a polymeric film cover by using heated extrudable material pressing said film into said teeth to form a film cover on the teeth and grooves on the toothed side of said belt. The present invention meets this need.

### SUMMARY OF THE INVENTION

The primary aspect of the invention is to produce a toothed belt having a polymeric film cover by using heated extrudable material pressing said film into said teeth to form a film cover on the teeth and grooves on the toothed side of said belt.

Other aspects of the invention will be pointed out or made obvious by the following description of the invention and the accompanying drawings.

The invention comprises a method of producing a toothed belt having teeth and grooves and a polymeric film cover thereon comprising the steps of rotating a forming wheel comprising alternating cavities and protrusions which correspond in cross section to a cross section of said toothed belt, extruding heated extrudable material onto the forming wheel, feeding a reinforcing member onto said forming wheel, feeding a polymeric film onto said forming wheel between the reinforcing member and the forming wheel, pressing said polymeric film into said cavities and upon said protrusions with said heated extrudable material thereby forming a polymeric film cover on the teeth and grooves, and cooling the toothed belt.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a cross-sectional view of the belt and process.

FIG. 2 is a detail of the mold cavity from FIG. 1.

FIG. 3 is a perspective view of the forming elements.

FIG. 4 is a cross-sectional view of the forming wheel.

FIG. 5 is a perspective view of an alternate embodiment of the forming wheel.

FIG. 6 is a perspective cross-section of an alternate embodiment of the belt.

FIG. 7 is a cross sectional end view of the belt in FIG. 1.

### DETAILED DESCRIPTION OF THE PREFERRED EMBODIMENT

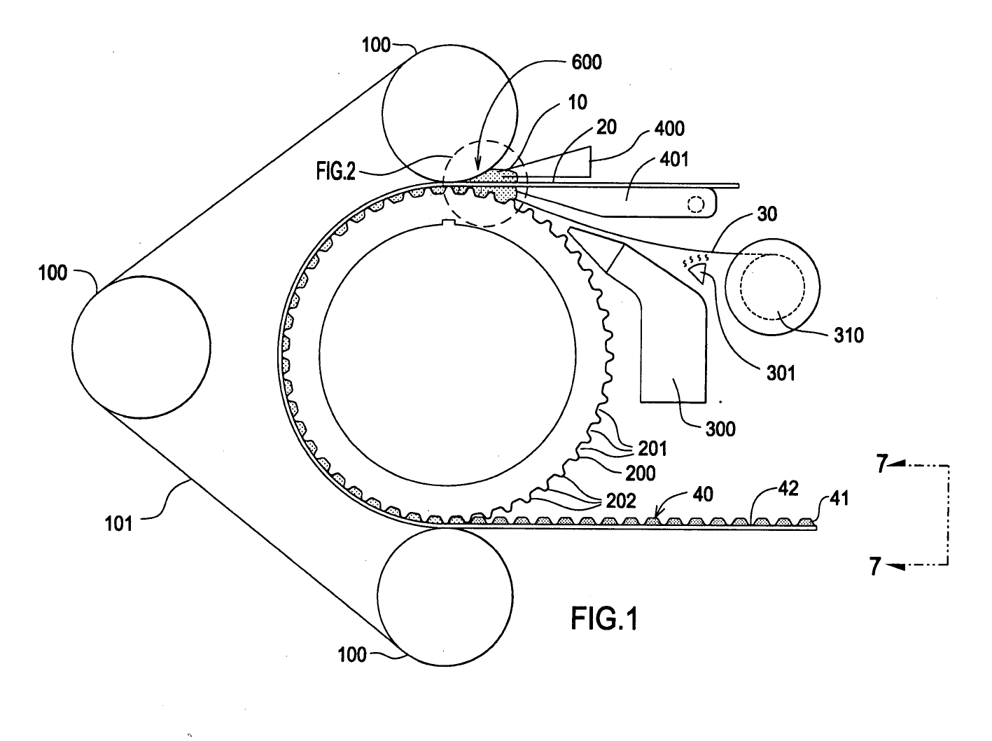

FIG. 1 is a cross-sectional view of the belt and process. The invention comprises a method of producing a toothed belt having teeth and grooves and a polymeric film cover thereon comprising the steps of rotating a forming wheel comprising alternating cavities and protrusions which correspond in cross section to a cross section of said toothed belt, extruding heated extrudable material onto the forming wheel, feeding a reinforcing member onto said forming wheel, feeding a polymeric film onto said forming wheel between the reinforcing member and the forming wheel, pressing said polymeric film into said cavities and upon said protrusions with said heated extrudable material thereby forming a polymeric film cover on the teeth and grooves, and cooling the toothed belt.

In particular the invention comprises a product and process, namely, a belt 40 which comprises a film 30. Film 30 comprises a polymeric material such as polyethylene, polypropylene, Mylar™, Nylon™, polyurethane, or a combination of two or more of the foregoing, or any other materials compatible with the film that may be applied to the face of the belt teeth.

The belt body also comprises a polymeric material such as polyurethane. However, selection of the film material also enables use of a thermoplastic or thermoset polymer for the belt body which is less durable and therefore expensive than polyurethane, for example, a thermoplastic elastomer (TPE) or thermoplastic vulcanite (TPV), including Santoprene™. The need for a durable belt body material is significantly reduced because the tooth wear is, of course now borne on the surface of the film 30. The belt body material need only be suitable to withstand the operational requirements otherwise unrelated to wear by abrasion of the tooth surface as the tooth surface contacts a sprocket surface.

The inventive process is used to extrude a polymeric belt with a film 30 applied to the teeth 41. The film is used to enhance the characteristics of the tooth surface. As a result the teeth are more wear resistant, quieter, have less friction, all without fabric fray or premature wear. The film also seals the reinforcing member thus preventing penetration of foreign matter, including liquids and microorganisms, into the belt body and reinforcing member.

The film 30 may have a thickness in the range of approximately 0.05 mm to approximately 1.0 mm. Greater film thicknesses may be achieved by applying more than one layer of film during the disclosed manufacturing process. The weight average molecular weight of the film may be in the range of approximately 10,000 grams/mole up to approximately 3,000,000 grams/mole.

Referring to FIG. 1, the extrusion equipment comprises rotating elements 100, an endless band 101 and forming wheel 200. Rotating elements 100, endless band 101 and forming wheel 200 move in a synchronous manner in order to properly form the belt 40 in a manner known in the art.

Endless band 101 is trained between the rotating elements 100. Band 101 contains the extruded polyurethane 10 on the forming wheel as the forming wheel rotates and the extruded polyurethane material cools.

Mold cavity 600 is formed between the endless band 101 and forming wheel 200 and the flashing rings 205, 206 into which the polyurethane 10 is extruded. The mold cavity 600 receives the extruded polyurethane 10, reinforcing members 20 and film 30. Endless band 101 encloses the mold cavity thereby containing the extruded polyurethane 10, reinforcing members 20 and film 30.

An outer surface of forming wheel 200 comprises cavities 201 and protrusions 202. The belt teeth 41 are formed in cavities 201 and the belt grooves 42 are formed by protrusions 202. In the preferred embodiment teeth 41 have a curvilinear cross sectional profile. In an alternate embodiment a trapezoidal tooth profile may be used as well.

As the endless band 101 and forming wheel 200 operate at the same linear speed, the belt body material polyurethane 10 is heated and extruded from extrusion die 400 into forming elements 101, 200 in a manner known in the art. Simultaneously, reinforcing members 20 are fed at an identical linear speed between the endless band 101 and forming wheel 200. Reinforcing members 20 are guided through the extrusion process by guide 401.

Simultaneously the film material 30 is fed at the same linear speed from spool 310 between the reinforcing members 20 and the forming wheel 200. Prior to engaging the forming wheel 200, film 30 is heated using a hot air heater 300 or any other form of heating known in the art. Preheating film 30 allows the film to more easily assume the shape of the forming wheel as the heated polymeric belt body material 10 is fed under pressure through extrusion die 400. The preheating temperature is selected to sufficiently soften film 30 without causing melting and excessive stretching. In an alternate embodiment, an infra-red heater 301 is used in lieu of the hot air heater 300 to preheat the film. Since the material 10 is heated prior to extrusion, one may also feed the film 30 into the forming wheel without preheating film 30.

The belt 40 comprises reinforcing members 20 which extend in the lengthwise (longitudinal) direction, see FIG. 7. The reinforcing members 20 allow the belt to be subjected to tensile loads during operation. In the preferred embodiment the reinforcing member material comprises Kevlar™, however, the reinforcing members 20 may also comprise steel, aramid, nylon, polyester, carbon fiber, or any combination of two or more of the foregoing. The reinforcing members provide the majority of the belt's tensile strength which allows the softer polymeric belt body material to be used since the belt body does not significantly contribute to the tensile strength. Softer polyurethane (relatively lower relative hardness) allows the belt to run on smaller diameter pulleys without cracking the polyurethane body. Reinforcing members 20 also minimize belt stretch during operation thus allowing increased belt life.

During the manufacturing process the reinforcing members 20 are sealed into the belt body by film 30. Sealing the reinforcing members 20 with film 30 prevents micro-organisms from being wicked into the reinforcing members during use, thus making the belt appropriate for sanitary food handling applications. Application of the film 30 assures that the reinforcing members are sealed, where in prior art belts any incomplete coverage of the belt body polymeric material around the reinforcing members could leave the reinforcing members exposed to ambient conditions, thereby allowing intrusion of foreign organisms and materials.

Belt 40 is formed having teeth 41 extending across the entire width of the belt. The cavities 201 and protrusions 202 extend across the entire width of forming wheel 200 and have a height suitable to the service intended.

The finished belt cools on forming wheel 200 as it turns and may be immediately collected on spools (not shown) for storage. Finished belt 40 comprises teeth 41 and grooves 42. The teeth and grooves extend across the width and transverse to the length of the belt. Teeth 41 have a curvilinear profile.

Various methods of manufacture may be used to manufacture the belt including application of the film 30 to the belt. These include but are not limited to:
1. DIRECT FEED WITHOUT HEAT. Film 30 is fed into the extrusion process. The pressure and heat of the hot extruded polyurethane material 10 presses film 30 against the forming wheel 200 thereby facing the teeth and grooves.
2. DIRECT FEED WITH HEAT. Film 30 is fed into the extrusion process and preheated in order to make it soft enough to conform to the forming wheel. The pressure of the hot extruded polyurethane 10 on the pre-heated film 30 presses the film against the forming wheel, thereby facing the teeth and grooves.
3. PREFORM OFF-LINE. The film 30 can be preformed to have the exact form of the tooth profile before going into the extrusion process. This provides good tooth form and uniform film thickness and wear resistance at all points on the tooth surface. This is accomplished by preforming the film 30 in a separate dedicated manufacturing line. The preformed film 30 is then fed into the extrusion process as described herein.
4. PREFORM IN-LINE. The preforming of the film 30 is preformed in-line before the final extrusion of polyurethane 10 is applied. The preformed film 30 is then fed into the extrusion process as described herein. In this alternative the film 30 is preformed in a step preceding application of the preform film 30 to the forming wheel 200. In each of cases #3 and #4 the film readily engages the cavities and grooves of forming wheel 200.

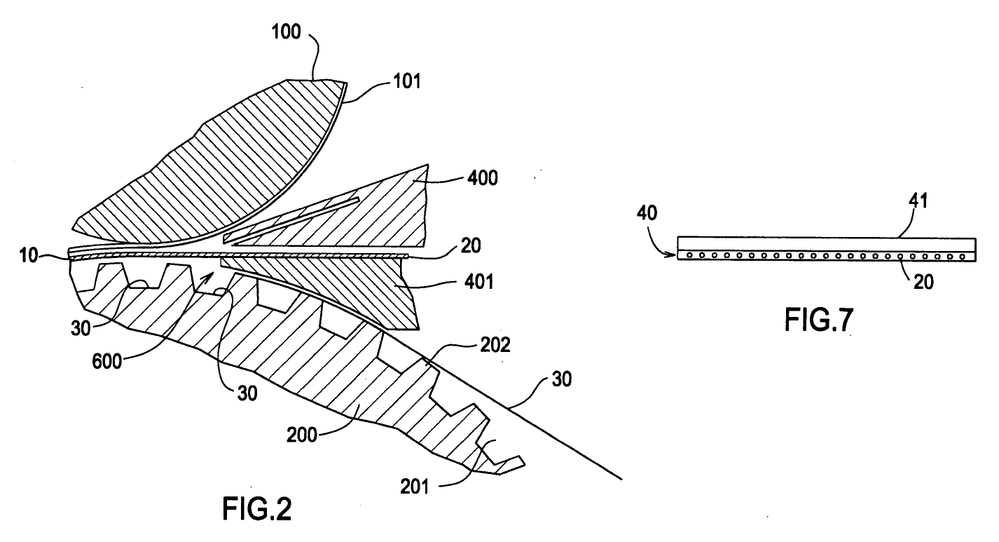

FIG. 2 is a detail of the mold cavity from FIG. 1. Flash ring 205 has been omitted from this figure for clarity. Film 30 is fed between forming wheel 200 and extrusion die 400. Film 30 is drawn into the forming elements 101 and 200 under little or no tension (less than approximately 5 newtons) in order to allow the extruded polymeric material 10 to force film 30 into cavities 201. In order to assure proper film feed spool 310 is rotated at a speed which assures proper feed timing with forming wheel 200. The system can include use of a web control system known in the art which may operationally rely in part on feedstock (film) tension.

FIG. 3 is a perspective view of the forming elements. In order to control the extruded material forming wheel 200 further comprises a flash ring 205 and 206. Endless band 101 engages an edge of each flash ring. The extruded material is contained between the flash rings 205, 206 and the forming wheel 200 and the endless band 101.

FIG. 4 is a cross-sectional view of the forming wheel. The edge of flash ring 205 comprises ridges 215. The edge of flash ring 206 comprises ridges 220. Ridges 215 and 220 provide a means of sealing the contact between endless band 101 and each flash ring. During the extrusion process a small portion of the extruded material will partially flow between endless band 101 and ridges 215 and 220. This causes some flash to be present on the edge of the completed belt, but it is a means of assuring that the edges of the belt are fully formed. The flash is the trimmed from the formed belt in a later step.

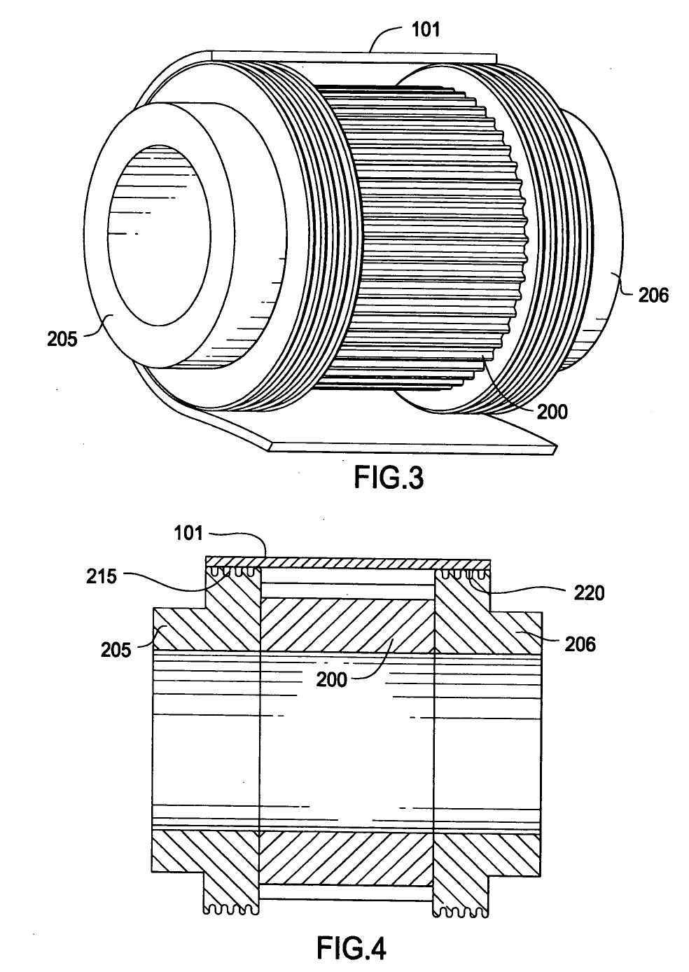

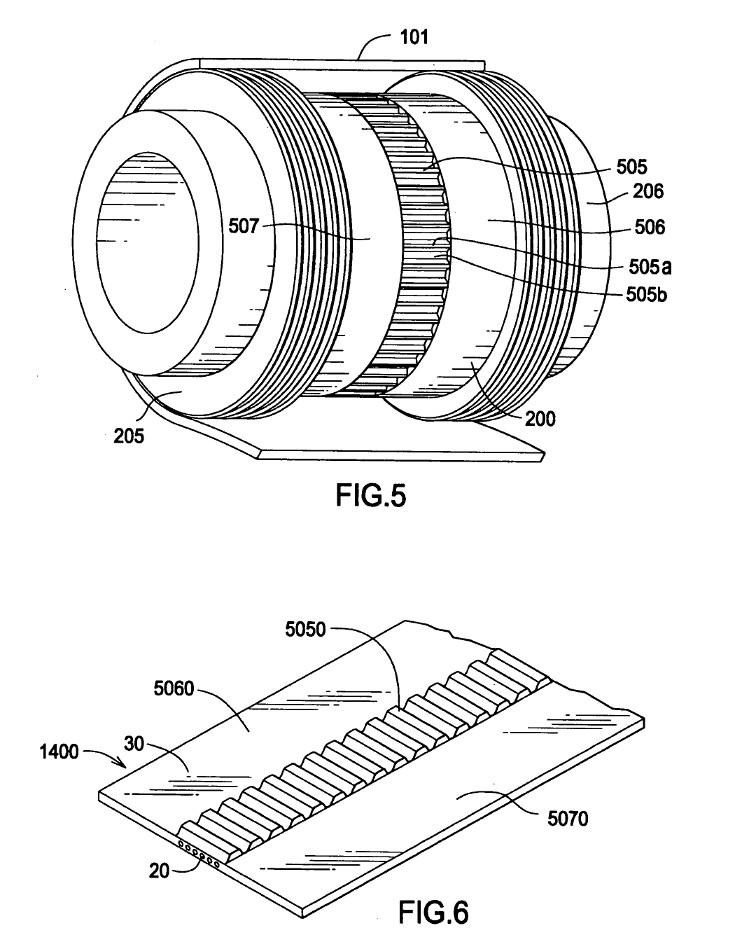

FIG. 5 is a perspective view of an alternate embodiment. In this alternate embodiment, a toothed portion only extends across a portion of the width of the belt, leaving flat portions on the remaining width. The toothed portion is typically aligned with the center of the belt, although the toothed portion may be offset to one side if necessary. In this embodiment the belt may be 18″ in total width. The toothed portion is manufactured using the process described herein. However, the toothed section is limited to a partial width of the belt, for example, approximately 3″ wide, leaving the remaining 15″ of belt width flat. In other words, on either side of the toothed section are 7.5″ wide flat belt sections (i.e. toothless). To manufacture this belt forming wheel 200 comprises 7.5″ wide flat sections on each side and a central portion having 3″ wide cavities 505b and protrusions 505a for creating the belt toothed center section. The dimensions described are only for the purpose of illustration since the toothed portion may comprise any width.

As similarly described in FIG. 1, a center portion 505 of forming wheel 200 comprises protrusions 505a and cavities 505b. Adjacent to the center portion are flat portions 506, 507. The center portion results in a belt having teeth disposed in a center section with adjacent flat outer portions, see FIG. 6.

FIG. 6 is a perspective cross-section of the alternate embodiment of the belt described in FIG. 5. Teeth 5050 are disposed along a center portion of belt 1400. Flat portions 5060 and 5070 are disposed along either side of teeth 5050. Reinforcing members 20 are embedded within the belt body. The reinforcing members can be either disposed under the teeth or extend across the width of the belt. Film 30 is applied over the flat portions 5060 and 5070 and teeth 5050 as described elsewhere in this specification.

Teeth 5050 may have any cross sectional form known in the belt art, including rectangular or curvilinear. For example, the tooth form depicted in U.S. Pat. No. 4,605,389, incorporated herein in it's entirety by reference, can be used.

It is also possible to use different film materials on different portions of the belt. For example, a different film material may be used on a toothed section as compared to a flat adjacent section. Hence, two or more adjacent film feeding lines are used to apply the different film materials to the belt being formed. Film materials may also be “stacked” in a layered arrangement having two or more layers of film to achieve a desired thickness. Further, film polymeric materials may comprise polyurethane or polyethylene or a combination of the two.

FIG. 7 is a cross sectional end view of the belt in FIG. 1. Teeth 41 extend across the width of belt 40. Reinforcing members 20 extend in a longitudinal direction through the belt. Teeth 41 may have any cross sectional form known in the belt art, including rectangular or curvilinear. For example, the tractrix tooth form disclosed in U.S. Pat. No. 4,605,389 can be used.

Although forms of the invention have been described herein, it will be obvious to those skilled in the art that variations may be made in the construction and relation of parts without departing from the spirit and scope of the invention described herein.

1. A method of manufacturing a toothed belt having teeth and grooves and a polymeric film cover thereon comprising the steps of:
rotating a forming wheel comprising alternating cavities and protrusions which correspond in cross section to a cross section of said toothed belt;
extruding heated extrudable material onto the forming wheel;
feeding a reinforcing member onto said forming wheel;
feeding a polymeric film onto said forming wheel between the reinforcing member and the forming wheel;
pressing said polymeric film into said cavities and upon said protrusions with said heated extrudable material thereby forming a polymeric film cover on the teeth and grooves; and
cooling the toothed belt.

2. The method as in claim 1 further comprising the step of preheating said polymeric film to a softening temperature prior to engaging said forming wheel.

3. The method as in claim 1 further comprising the step of preforming said polymeric film prior to engaging said forming wheel.

4. The method as in claim 1 comprising the step of forming teeth on a partial width of said toothed belt.

5. The method as in claim 1, wherein the polymeric film comprises polyurethane.

6. The method as in claim 1, wherein the polymeric film comprises polyethylene.

7. The method as in claim 1, wherein the polymeric film comprises polypropylene.

8. The method as in claim 1, wherein the reinforcing member comprises carbon fiber.

9. The method as in claim 1, wherein the reinforcing member comprises Kevlar™, steel, aramid, nylon, polyester, or any combination of two or more of the foregoing.

10. The method as in claim 1, further comprising sealing the reinforcing members within the belt using the polymeric film.
